(19) United States
(12) Patent Application Publication
(10) Pub. No.: US 2014/0321288 A1
(43) Pub. Date: Oct. 30, 2014

(54) WIRELESS COMMUNICATION SYSTEM AND TRAFFIC CONTROL METHOD THEREOF

(71) Applicant: Samsung Electronics Co., Ltd., Suwon-si, Gyeonggi-do (KR)

(72) Inventors: In Dae Ha, Suwon-si (KR); Dong Ho Kwak, Hwaseong-si (KR); Sung Kwan Kim, Suwon-si (KR); Hoon Jae Kim, Seoul (KR)

(21) Appl. No.: 14/358,535

(22) PCT Filed: Dec. 7, 2012
(86) PCT No.: PCT/KR2012/010591

§ 371 Date: May 15, 2014

(30) Foreign Application Priority Data
Dec. 8, 2011 (KR) 10-2011-0131167

(51) Int. Cl. H04W 28/02; H04L 12/823

(52) U.S. Cl. CPC H04W 28/0231; H04L 47/32; H04W 28/0268
USPC 370/237

(57) ABSTRACT

A data traffic control method and system is provided for controlling data transmission amount efficiently in a Long Term Evolution (LTE) system. The traffic control method of the present invention includes monitoring to detect overload of traffic by checking radio resource usage periodically; checking, when traffic overload is detected, a non-controlled packet ratio; and determining whether to control the traffic depending on the non-controlled packet ratio.

### TECHNICAL FIELD

The present invention relates to a wireless communication system for providing mobile communication service and traffic control method there and, in particular, to a method and system for controlling data transmission amount efficiently in a Long Term Evolution (LTE) system.

### BACKGROUND ART

It is a recent tendency that the data traffic increases gradually in wireless networks as well as the legacy wired networks (e.g. Ethernet, IP, MPLS, etc.), and thus the radio network load increases too. For example, with the widespread use of User Equipment (UE), the number of mobile communication service users increase abruptly. This means the increase of the number of heavy users too. The heavy users are of generating excessive data traffic in the mobile communication service, e.g. peer to peer (P2P) users or web header users uploading heavy traffic volume. As traffic generated by the relatively small number of heavy users occupy the network resources excessively, this influences the resource allocated to the most other users.

Meanwhile, Long Term Evolution (LTE) system as evolved Universal Mobile Telecommunication System (UMTS) controls the traffic per Quality of Service (QoS) Class Identifier (QCI). For example, if a UE attaches to the LTE system, a default bearer can be established for traffic flow. On the default bearer, the traffic identified by 5-tuple predefined by the UE or the Evolved Packet Core (EPC) can flow. That is, the traffic flows on the default bearer which is maintain until the UE detaches from the LTE system. At this time, the traffic is called user traffic flow or IP flow and identified by a 5-tuple (source IP address, destination IP address, protocol ID, source port, and destination port) of the packet.

If a service identified by a QCI is requested in the state where the traffic flows on the default bearer, a dedicated bearer can be established. On the dedicated bearer, the traffic of the corresponding service identified by the QCI can flow. At this time, a bases station (evolved Node B or eNB) of the LTE system is capable of scheduling per QCI and controlling the traffic based on the traffic property.

### DISCLOSURE OF INVENTION

### Technical Problem

In the LTE system, however, although the traffic control method based on QCI is advantageous to control the Guaranteed Bit Rate (GBR) traffic (e.g. traffic type for which bandwidth is guaranteed, such as voice service), there is a difficulty in controlling non-GBR (the best effort type traffic for which bandwidth is not guaranteed, such as best effort service). That is, in the conventional QCI-based traffic control method where the traffic is identified by 5-tuple has a drawback in that, if the traffic of a service has no fixed 5-tuple, there is no way to control the traffic using QCI. Furthermore, the conventional QCI-based traffic method does not allow the network operator to control the traffic per service in a traffic class (e.g. traffic control for a heavy user generating excessive traffic). There is therefore a need of a method for the network operator to discriminate among services to control the traffic per service in real time.

### Solution to Problem

The present invention has been made in an effort to solve the above problem and it is an object of the present invention to provide a traffic control method and system for adjusting the data transmission amount in a wireless communication system.

It is another object of the present invention to provide a traffic control method and system that is capable of controlling traffic per service in a wireless communication system.

It is still another object of the present invention to provide a traffic control method and system that is capable of discriminating among services belonging to the same class (QCI) and controlling the traffic per service.

In accordance with an aspect of the present invention, a traffic control method includes monitoring to detect overload of traffic by checking radio resource usage periodically; checking, when traffic overload is detected, a non-controlled packet ratio; and determining whether to control the traffic depending on the non-controlled packet ratio.

In accordance with another aspect of the present invention, a traffic control system includes an Evolved Packet Core (EPC) which detects a packet carrying user traffic, marks a Differentiated Services Code Point (DSCP) of a header of the detected packet with a predetermined value, and transmits packet; and a base station which determines whether to control traffic based on radio resource usage and non-controlled packet ratio and controls the traffic according to determination result.

The foregoing has outlined rather broadly the features and technical advantages of the present invention in order that the detailed description of the invention that follows may be better understood. Additional features and advantages of the invention will be described hereinafter which form the subject of the claims of the invention.

### Advantageous Effects of Invention

The traffic control method and system of the present invention is capable of adjusting the data amount transmitted in the wireless communication system, thereby reducing network load and managing network traffic efficiently. The traffic control method of the present invention is capable of controlling the traffic efficiently based on the QCI even when the service has no fixed 5-tuple. Particularly, the traffic control method and system of the present invention is capable of differentiating among the traffics of different services in the same traffic class (QCI) according to the network operator's intention, thereby controlling the traffic efficiently. For example, when the abnormal traffic (i.e. heavy traffic) caused by the heavy upload of P2P or web-hard users that occupies the resource excessively is detected, the traffic control method of the present invention is capable of controlling the resource occupancy of the heavy user's traffic below a predetermined level.

Also, the traffic control method and system of the present invention is capable of controlling abnormal traffic below a predetermined level by suppressing the traffic overload caused by the heavy users, thereby ensuring the reliable flow of normal traffic. That is, the present invention is advantageous to solve the normal service traffic quality degradation problem caused by the excessive resource occupancy of the heavy user traffic. Also, the traffic control method and system of the present invention is capable of implementing an optimal wireless communication system environment for supporting the traffic control, resulting in improvement of service quality.

### BRIEF DESCRIPTION OF DRAWINGS

FIG. 1 is a diagram illustrating the architecture of the traffic control system according to an embodiment of the present invention;

FIG. 2 is a diagram illustrating the principle of traffic control procedure in the protocol stack architecture of the traffic control system according to an embodiment of the present invention;

FIG. 3 is a signal flow diagram illustrating the traffic control procedure in the traffic control system according to an embodiment of the present invention;

FIG. 4 is a flowchart illustrating the traffic control method in the traffic control system according to an embodiment of the present invention;

FIG. 5 is a flowchart illustrating the traffic control method of the traffic control system according to another embodiment of the present invention; and

FIG. 6 is a graph illustrating the effect of the traffic control according to an embodiment of the present invention.

### MODE FOR THE INVENTION

Exemplary embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention. That is, the description is made only with the operations necessary in the embodiments of the present invention, and other parts that may cause obscurity of the subject matter of the present invention are omitted.

The present invention relates to a wireless communication system for providing wireless communication service and traffic control method thereof. An embodiment of the present invention proposes a traffic control method and system that is capable of controlling the traffic amount of the wireless communication efficiently. Particularly, the present invention relates to the traffic control method and system that is capable of controlling the traffics per service based on the QCI used in the LTE system.

According to the present invention, the traffic control method includes marking Differentiated Services Code Point (DSCP) for the packet inspected through Deep Packet Inspection (DPI) at the Evolved Packet Core (EPC) of the LTE system, determining overload of the Evolved Node B (eNB) based on the radio resource usage (particularly, usage of Physical Resource Block (PRB), and controlling traffic on the Packet Data Convergence Protocol (PDCP) layer of the eNB. In the present invention, the traffic control method includes determining whether to perform traffic control to makes a traffic control decision, which includes comparing measured PRB usage with a predetermined threshold radio resource usage (particularly, threshold PRB usage) and comparing non-controlled normal traffic packet (hereinafter, non-controlled packet) throughput with a minimum threshold.

The following description on the present invention can be applied to the LTE system and traffic control method thereof. However, the present invention is not limited thereto but can be applied to all the types of wired and wireless communication system having the similar technical background and channel structure without departing from the spirit and scope of the present invention. For example, the present invention can be applied to a 3GPP communication technology, especially, Universal Mobile Telecommunications System (UMTS).

The traffic control system and method according to an embodiment of the present invention is described with hereinafter with reference to accompanying drawings. However, the present invention is not limited to the embodiments in the following description, but can be implemented into various changes and modifications.

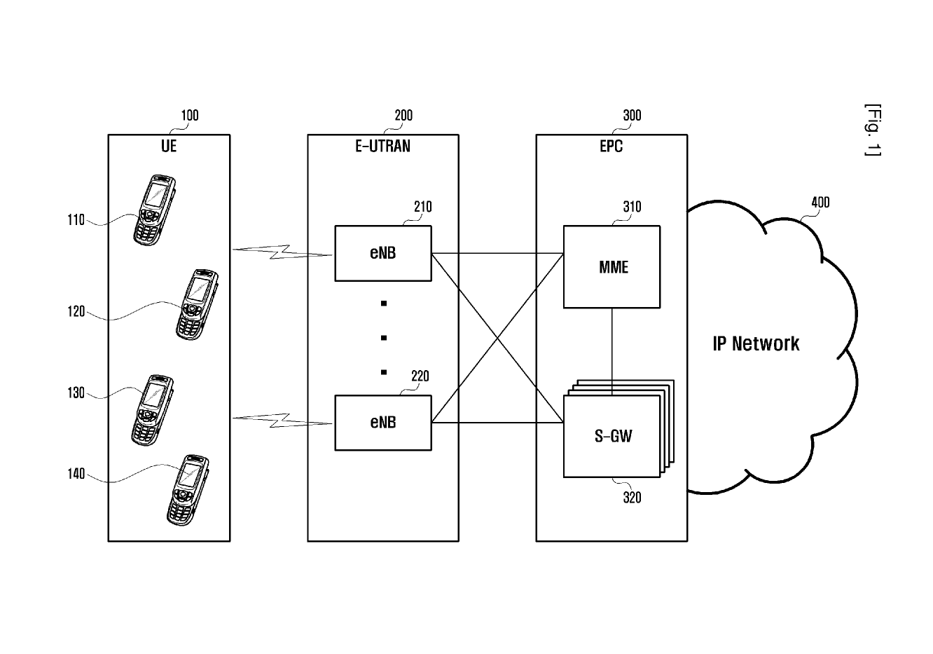

FIG. 1 is a diagram illustrating the architecture of the traffic control system according to an embodiment of the present invention.

Referring to FIG. 1, the traffic control system according to an embodiment of the present invention includes a UE 100, an Evolved UMTS Terrestrial Radio Access Network (E-UTRAN) 200, an Evolved Packet Core (EPC) 300, and an Internet Protocol (IP) network 400.

The UE 100 can be any of terminals capable of IP-based multimedia service (such as voice, video, location, instant message services) and fulfilling the capability requirements of the traffic control system. For example, the UE 100 can be any of mobile communication terminals operating based on various communication protocols adopted by respective communication systems, tablet Personal Computer (PC), smartphone, Portable Multimedia Player (PMP), media player, laptop computer, and Personal Digital Assistant (PDA). There are a plurality of UEs 110, 120, 130, and 140 in the traffic control system as shown in FIG. 1.

The E-UTRAN 200 is capable of including a plurality of eNBs 210 and 220 serving the UEs 100.

Each of the eNBs 210 and 220 delivers the uplink signals transmitted by the UE 100 to the EPC 300 and the downlink signals from the EPC 300 to the UE 100. That is, each of the eNBs 210 and 220 communicates signals with the UE 100 and works as an Access Point (AP) to connect the UE 100 to the UTRAN 200. The eNB manages radio resource per cell to establish a radio channel with the UE 100 within the cell, i.e. allocates and releases radio resource to the UE 100. Particularly, each of the eNBs 210 and 220 is capable of performing a process related to the traffic control of the present invention. For example, when a packet is received from the EPC 300, the eNB checks overload based on the PRB usage to determine whether to perform traffic control for the packet. The eNB is capable of controlling to drop the packet or transmit the packet to the UE 100 depending on the determination result. In the following, the description is made under the assumption that the UE 100 attaches to the eNB 210 for the convenience purpose.

The EPC 300 includes a Mobility Management Entity (MME) 310 responsible for control plane functions and a Serving Gateway (S-GW) 320 responsible for user plane functions. Particularly, the EPC 300 is capable of inspecting the packet through DPI for the user traffic and marking the DSCP, in the header (IP header) of the packet, with a specific value negotiated with the eNB 210.

The MME 310 is connected to the eNB 210 for managing the mobility of the UE 100 and access information and exchanges control messages with the eNB 210. The MME 310 also controls bearer (tunnel) establishment based on the service property and provides the UE 100 with authentication interface.

The S-GW 320 works as the gateway for interoperation with the IP network 400. That is, the S-GW 320 allocates bearers and manages established bearer for the service provided to the UE 100. The S-GW 320 allocates and IP address to the UE 100 and works as a mobility anchor in the handover of the UE 100 between eNBs 210 and 220. The S-GW 320 is also filtering the packet received from the IP network 400 and delivers the packet to the UE 100 via the eNB 210 through the bearer allocated the UE 100. At this time, the S-GW 320 filters the packets from the IP network 400 such that only the packets addressed to the UE 100 connected to the eNB is delivered on the correct bearer.

Meanwhile, the eNB 210 is provided with a radio interface protocol stack. The radio interface protocol stack split horizontally into a physical layer, a Data Link Control layer, and a Network layer and vertically into a user plane for user data transmission and a control plane for control signaling. Typically, the radio interface protocol stack is divided into an L1 layer including Physical (PHY) layer, an L2 layer including Medium Access Control (MAC) layer, Radio Link Control (RLC) layer, and PDCP layer, and an L3 layer including Radio Resource Control (RRC) layer based on the three lower layers of the Open System Interconnection (OSI) reference model well-known in the radio communication field. The protocol layers are connected in pairs for data transmission between the UE 100 and the E-UTRAN 200.

The PHY layer offers information transfer service to the higher layer using physical channels. The PHY layer connects to the MAC layer through transport channels on which the data flow between the MAC and PHY layers. At this time, the transport channels are divided into dedicated transport channels and common transport channels. The data transfer between two physical layer entities is performed through the physical channel using radio resource.

There are several L2 sub-layers. First, the MAC layer is responsible for mapping logical channel and transport channels and logical channel multiplexing for mapping several logical channels to one transport channel. The MAC layer is connected with the RLC layer through logical channels which are divided into control channel for transferring control-plane information and traffic channel for transferring user plane information according to the type of the information.

The L2 RLC layer is responsible for segmentation and concatenation of the data from the higher layer to adjust the data size appropriate for transmission over the radio link. The RLC layer supports three operation modes of Transparent Mode (TM), Unacknowledged Mode (UM), and Acknowledged Mode) for guaranteeing various levels of Quality of Service (QoS) required on the respective Radio Bearers (RBs). Particularly, the AM RLC entity is capable of performing retransmission based on Automatic Repeat and Request (ARQ) for reliable data transmission.

The L2 PDCP layer is responsible for header compression function for reducing the size of the IP packet header contain relatively large and redundant control information to improve transmission efficiency on the radio link having narrow bandwidth in Internet Protocol version 4 (IPv4) or IPv6 packet transmission. This is capable of increasing the transmission efficiency on the radio link by configuring the IP packet header only with essential information. In the LTE system, the PDCP layer is also responsible for security function which includes the ciphering for preventing third party eavesdropping and the integrity protection against third part data manipulation.

The RRC layer as the highest L3 layer is defined only for the control plane and responsible for controlling logical channels, transport channels, and physical channels in association with radio bearer configuration, reconfiguration, and release. Here, the radio bearer means a logical path provided by L1 and L2 layers of the radio protocol stack for data transfer between the UE 100 and the eNB 210 and 220, and establishing a radio bearer can be interpreted as the procedure for specifying the radio protocol layers and channel properties necessary for providing a specific service and configuring detailed parameters and operation mode.

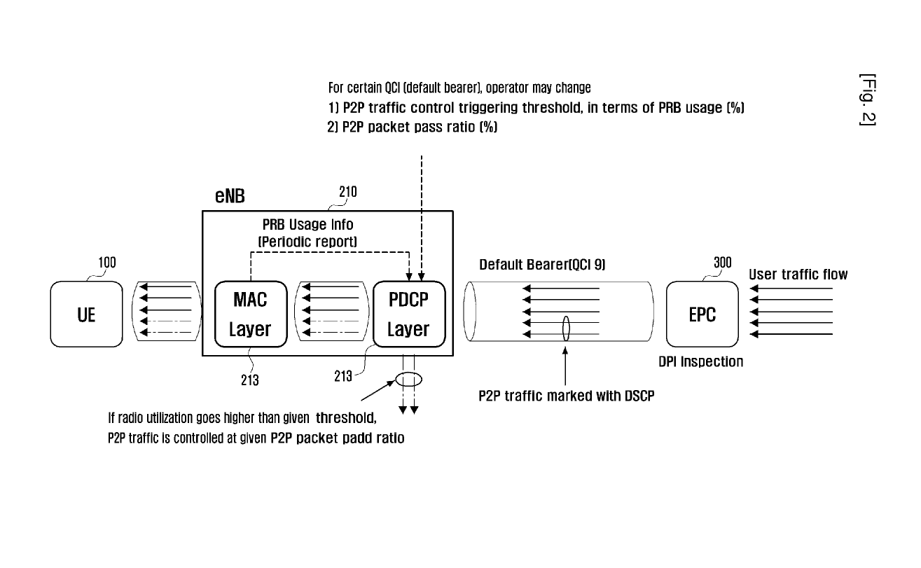

A description is made of the traffic control operation of the above-described traffic control system in detail hereinafter with reference to FIG. 2.

FIG. 2 is a diagram illustrating the principle of traffic control procedure in the protocol stack architecture of the traffic control system according to an embodiment of the present invention.

Referring to FIGS. 1 and 2, the EPC 200 is capable of inspecting the packets transmitted by a specific UE using DPI, marking the DSCP of the header (IP header) of the inspected packet with a value negotiated with the eNB 210, and transmitting the packet to the eNB 210. Here, the DSCP denotes a field of the IP packet header provided for classifying the services carried by packets. The user traffic flowing through the established default bearer (tunnel) is called user traffic flow and identified by the 5-tuple of the packet (Source IP address, Destination IP address, Protocol ID, Source Port, and Destination port). When the UE 100 attaches to the eNB 210, one bearer is established. This one bearer is referred to as default bearer. The default bearer can be used until the UE 100 detaches from the eNB 210.

At this time, the QCI property of the default bearer indicates Non-Guaranteed Bit Rate (Non-GBR), i.e. the best effort type property not guaranteeing the quality of service. The QCI indicates the QoS priority with an integer in the range from 1 to 9 and each value contains properties (values) such as resource type (GBR or Non-GBR), priority (1 to 9), Packet Delay Budget, Packet Error Loss Rate. That is, the QoS on the bearer depends on the QCI value: QCI=1 for the higher priority and QCI=9 for the lowest. For example, it can be defined as “QCI=1: Resource Type=GBR, Priority=2, Packet Delay Budget=100 ms, Packet Error Loss Rate=10̂-2, Example Service=Voice” and “QCI=9: Resource Type=Non-GBR, Priority=9, Packet Delay Budget=300 ms, Packet Error Loss Rate=10̂-6, Example Service=Internet”. Accordingly, when then eNB 210 performs packet transmission control on the radio link, it is possible to determine the priority of the packet transmission in consideration of the QCI properties and control the packet transmission based on the determination result.

Next, the eNB 210 monitors (measures) the PRB usage periodically, the monitored (measured) PRB usage is delivered from the MAC layer 211 to the PDCP layer 213. Here, the PRB usage is one of the informations used in the load balancing and Call Admission Control (CAC) among the cells in the LTE system and indicates the usage amount of the time and/or frequency resources.

Next, the PDCP layer 213 of the eNB 210 checks the PRB usage amount received from the MAC layer 211 and determines whether to perform traffic control according to the checking result. At this time, the PRB usage measured by the PDCP layer 213 of the eNB may be compared with the threshold PRB usage predetermined by the operator. If the PRB usage is greater than the threshold PRB usage, the PDCP layer 213 of the eNB 210 starts traffic control for the traffic inbound from the EPC 200. Otherwise, if the PRB usage is equal to or less than the threshold PRB usage, the PDCP layer 213 of the eNB 210 does not control the traffic inbound from the EPC 300. That is, the PDCP layer 213 of the eNB 210 sets the Traffic Control Flag to off (Traffic Control Flag =Off).

At this time, if all packets inbound from the EPC 300 are regarded as the targets of control (hereinafter, referred to as controlled packet), it may lead to experience significant packet drop may occur. In order to avoid this problem, the present invention configures a minimum threshold for skipping traffic control when the non-controlled ratio is below a predetermined level. That is, when the PRB usage is greater than the threshold PRB usage, the PDCP layer 213 of the eNB 210 checks the non-controlled ratio to determine whether to control the traffic based on the checking result. At this time, the PDCP layer 123 of the eNB 210 is capable of comparing the non-controlled ratio with the predetermined minimum threshold value. Here, the minimum threshold value may indicate a reference value for determining the non-controlled ratio as compared to the all packets of the entire traffic. If the non-controlled ratio is greater than the minimum threshold value, the PDCP layer 213 of the eNB 210 starts controlling the traffic inbound from the EPC 200. That is, the PDCP layer 213 of the eNB 210 sets the Traffic Control Flag to on.

If a packet is received from the EPC 200, the PDCP layer 213 of the eNB 210 checks the stat of the traffic control flag set according to the above procedure. If the traffic control flag is set to Off, the PDCP layer 213 of the eNB 210 processes the packet transmission to the UE 100 without traffic control operation. In the case that the packet is transmitted without traffic control, the PDCP layer 213 of the eNB 210 may increase the non-controlled packet counter.

If the traffic control flag is set to On, the PDCP layer 213 of the eNB 210 compares the DSCP value in the header (IP header) of the packet with a predetermined reference DSCP value. If the DSCP value of the received packet and the reference DSCP value mismatch, the PDCP layer 213 of the eNB 210 is capable of transmitting the received packet to the corresponding UE 100 without traffic control. At this time, the PDCP layer 213 of the eNB 210 may increase the counter of the non-controlled packet according to the packet transmission without traffic control.

If the DSCP value of the received packet and the reference DSCP value match each other, the PDCP layer 213 of the eNB 210 controls the traffic.

According to the traffic control operation, the PDCP layer 213 of the eNB 210 may check the controlled ratio as compared to all packets of the entire traffic. At this time, if the controlled packet ratio is greater than a predetermined reference ratio (pass ratio), the PDCP layer 213 of the eNB 210 controls to drop the received packet. Otherwise, if the controlled packet ratio is equal to or less than the predetermined reference ratio, the PDCP layer 213 of the eNB 210 transmits the packet from the EPC 300 to the UE 100. At this time, the PDCP layer 213 of the eNB 210 may increase the controller packet counter according to the transmission of the packet under the traffic control.

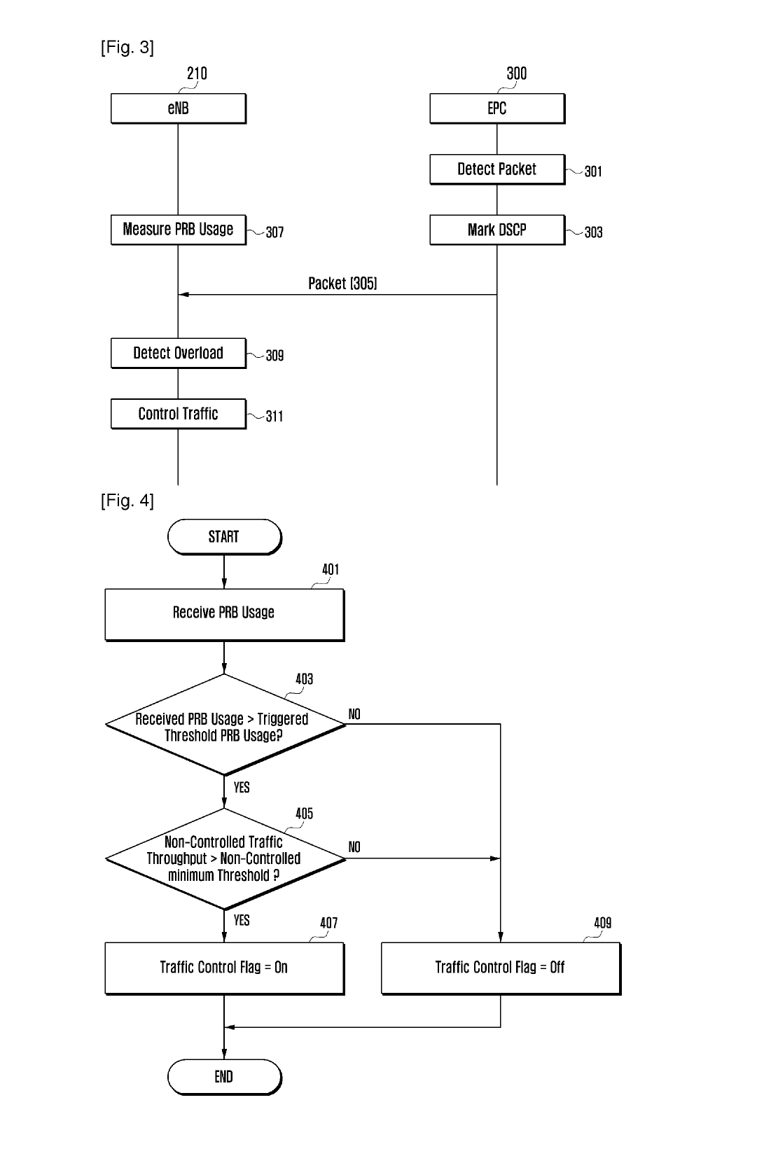

FIG. 3 is a signal flow diagram illustrating the traffic control procedure in the traffic control system according to an embodiment of the present invention.

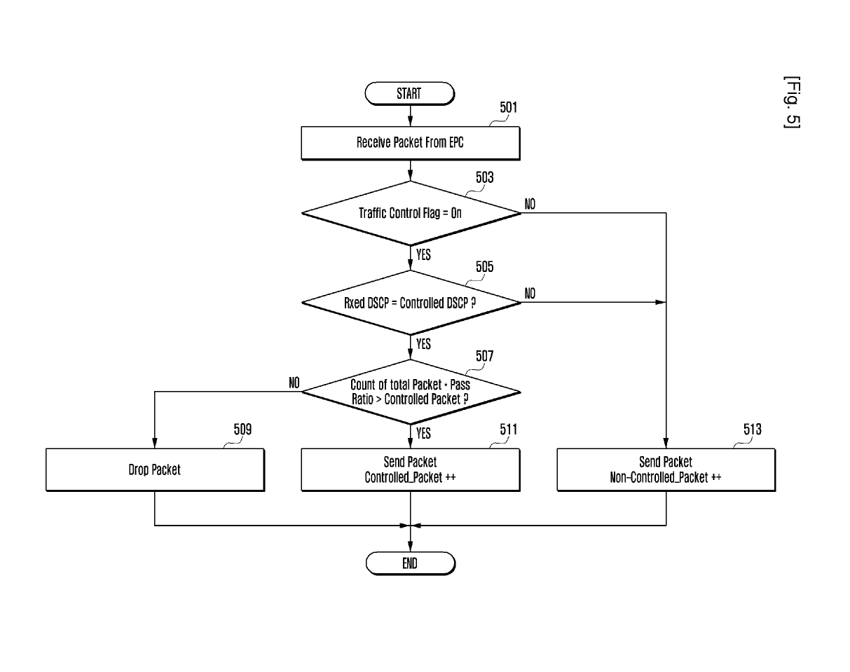

Referring to FIG. 4, the EPC 300 inspects the packet of user traffic using the DPI at step 301. Next, the EPC 300 marks the DSCP field of the header (IP header) of the inspected packet with a value negotiated with the eNB 210 at step 303. The EPC 300 sends the packet having the modified header to the eNB 210 at step 305.

Meanwhile, the eNB 210 measures the PRB usage periodically at step 307 and, if the packet transmitted by the EPC 300 is received, determines whether the traffic overload has occurred based on the PRB usage at step 309.

The eNB 210 is capable of performing traffic control on the received packet according to the traffic overload determination result at step 311. The traffic control method is described in detail with reference to FIGS. 4 and 5.

FIG. 4 is a flowchart illustrating the traffic control method in the traffic control system according to an embodiment of the present invention. Particularly, FIG. 4 is directed to the procedure for determining whether to perform the traffic control based on the measured PRB usage.

Referring to FIG. 4, the eNB 210 acquires a PRB usage at step 401 and compares the acquired PRB usage with a triggered threshold PRB usage at step 403. At this time, the MAC layer 211 of the eNB 210 is capable of measuring the PRB usage periodically and delivering the measured PRB usage to the PDCP layer 213. The PDCP layer 213 of the eNB 210 is capable of firstly determining whether to control the traffic by referencing the measured PRB usage and the predetermined threshold PRB usage. That is, the eNB is capable of setting the traffic control flag to On or Off state.

If it is determined that the measured PRB usage is equal to or less than the threshold

PRB usage at step 403, the eNB 210 sets the traffic control flat to Off at step 409.

Otherwise, if it is determined that the measured PRB usage is greater than the threshold PRB usage at step 403, the eNB 210 compares the non-controlled traffic throughput with a predetermined minimum threshold at step 405. Here, the minimum threshold can be a reference value for determining the ratio of the non-controlled packet as compared to all transmission packets of the entire traffic. That is, the eNB 210 is capable of determining whether to control the traffic secondly by referencing the non-controlled traffic throughput and the minimum threshold at the PDCP layer 213. That is, the eNB 210 is capable of determining the state of the traffic control flag.

If it is determined that the non-controlled traffic throughput is equal to or less than the non-controlled minimum threshold at step 405, the eNB 210 sets the traffic control flag to Off at step 409.

Otherwise, if it is determined that the non-controlled traffic throughput is greater than the minimum threshold at step 405, the eNB 210 sets the traffic control flag to On at step 407.

FIG. 5 is a flowchart illustrating the traffic control method of the traffic control system according to another embodiment of the present invention. Particularly, FIG. 5 is directed to the traffic control procedure when a packet is received from the EPC 300.

Referring to FIG. 5, the eNB 210 first receives a packet from the EPC 300 at step 501. At this time, it is assumed that the packet has the DSCP field marked, by the EPC 300, with a value negotiated with the eNB 210 in its header (IP header) and carries heavy traffic such as P2P service.

If the packet is received from the EPC 300, the eNB 210 checks the state of the traffic control flag at step 503. That is, the eNB 210 is capable of determining whether the traffic control flag is set to On or Off.

If the traffic control flag is set to Off (NO at step 503), the eNB 210 sends the packet to the UE 100 without any traffic control at step 513. At this time, the packet transmission can be a factor for use in determining whether to control the traffic afterward. In order to accomplish this, the eNB 210 increase the non-controlled packet counter when the received packet is transmitted with no traffic control.

Otherwise, if the traffic control flag is set to On (Yes at step 503), the eNB compares the DSCP value of the received packet with a predetermined reference DSCP value to determine whether the DSCP values match at step 505. For example, if the DSCP values match, the eNB 210 regards the packet as the controlled packet occurring heavy traffic so as to perform the traffic control operation. Otherwise, if the DSCP values mismatch, the eNB 210 regards the packet as the non-controlled packet carrying normal traffic so as not to perform the traffic control operation.

If the DSCP values mismatch (NO at step 505), the eNB 210 regards the packet as the non-controlled packet and thus sends the packet without any traffic control at step 513. At this time, the eNB 210 increases the non-controlled packet counter as the packet is transmitted with no traffic control.

If the DSCP values match (YES at step 505), the eNB 210 regards the packet as the controlled packet carrying heavy traffic so as to determine to perform traffic control and checks the controlled packet ratio compared to all transmission packets of the entire traffic at step 507. At this time, the eNB 210 compares the entire controlled packet ratio with the reference ratio (pass ratio) according to the operator's configuration. That is, the eNB 210 compares the count of the controlled packets among the entire transmission packets with a threshold controlled packet count preset by the operator. In this way, the present invention is capable of controlling the heavy traffic based on the reference ratio for the give heavy packet.

If the controlled packet ratio is equal to or greater than the threshold ratio (NO at step 507), the eNB 210 controls to drop the received packet according to the traffic control operation at step 509. For example, the eNB 210 determines that the packet amount exceeds the allowed maximum bandwidth and thus discards the received packet according to the traffic control operation.

If the controlled packet ratio is less than the threshold ratio (YES at step 507), the eNB 210 sends the received packet at step 511. For example, if although the packet is a controlled packet occurring heavy traffic there is room to reach the maximum bandwidth, the eNB 210 is capable of sending the received packet at step 511. At this time, the eNB 210 increases the controlled packet count as the packet is transmitted.

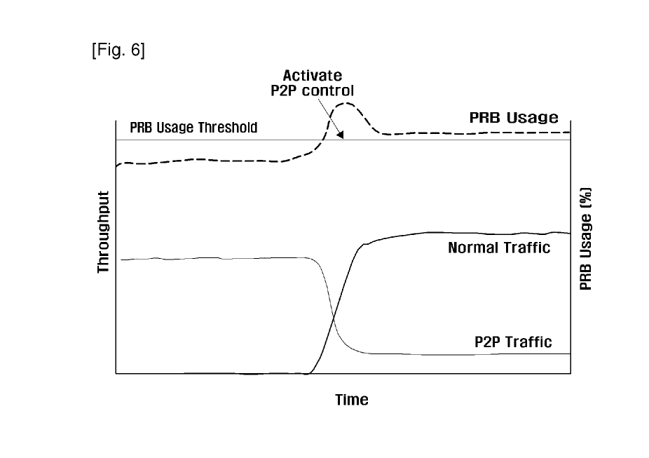

FIG. 6 is a graph illustrating the effect of the traffic control according to an embodiment of the present invention.

Referring to FIG. 6, the traffic processing method of the present invention is capable of controlling specific traffic in the CQI as described above. As shown in FIG. 6, if a non-controlled packet is transmitted in the state where the P2P traffic occupies the most of the resource, the traffic control mechanism is activated. Accordingly, the P2P traffic is controlled below a predetermined level such that the normal traffic flows normally. In the case that the traffic control method of the present invention is not applied, the excessive P2P traffic influences the normal traffic flow, resulting in degradation of service quality. The present invention overcomes this problem efficiently.

Although exemplary embodiments of the present invention have been described in detail hereinabove with specific terminology, this is for the purpose of describing particular embodiments only and not intended to be limiting of the invention. While particular embodiments of the present invention have been illustrated and described, it would be obvious to those skilled in the art that various other changes and modifications can be made without departing from the spirit and scope of the invention.

1. A traffic control method comprising:
monitoring to detect overload of traffic by checking radio resource usage periodically;
checking, when traffic overload is detected, a non-controlled packet ratio; and
determining whether to control the traffic depending on the non-controlled packet ratio.

2. The traffic control method of claim 1, wherein determining comprises
comparing, when measuring the radio resource usage, the measured radio resource usage with a predetermined threshold radio resource usage.

3. The traffic control method of claim 2, wherein checking comprises
comparing, when the measured radio resource usage is greater than the threshold radio resource usage, the non-controlled packet ratio with a predetermined minimum threshold, and
wherein determining comprises setting, when the measured radio resource usage is equal to or less than the threshold radio resource usage, a traffic control flag to Off.

4. The traffic control method of claim 3, wherein determining comprises:
setting, when the non-controlled packet ratio is equal to or less than the minimum threshold, a traffic control flag to Off; and
setting, when the non-controlled packet ratio is greater than the minimum threshold, the traffic control flag to On.

5. The traffic control method of claim 1, further comprising marking, when a packet carrying user traffic is detected, a Differentiated Services Code Point (DSCP) of a header of the detected packet with a predetermined value.

6. The traffic control method of claim 5, further comprising:
checking, when the packet is received, a traffic control flag;
comparing, when the traffic control flag is set to On, the DSCP of the received packet with a predetermined reference DSCP;
judging the received packet, when the DSCP match, as a controlled packet to be traffic-controlled and, when the DSCPs mismatch, as a non-controlled packet to be not traffic-controlled;
transmitting, when the traffic control flag is set to Off, the received packet; and
increasing a non-controlled packet count as the packet is transmitted.

7. The traffic control method of claim 6, wherein comparing comprises:
transmitting, when the DSCPs mismatch, the received packet without traffic control; and
increasing a non-controlled packet count as the packet is transmitted.

8. The traffic control method of claim 6, wherein comparing comprises:
determining, when the DSCPs match, to perform the traffic control; and
checking a controlled packet ratio to all transmission packets of entire traffic.

9. The traffic control method of claim 8, wherein checking comprises:
comparing the controlled packet ratio with a threshold ratio set by an operator;
dropping, when the controlled packet ratio is greater than the threshold ratio, the received packet; and
transmitting, when the controlled packet ratio is equal to or less than the threshold ratio, the received packet.

10. A traffic control system comprising:
an Evolved Packet Core (EPC) which detects a packet carrying user traffic, marks a Differentiated Services Code Point (DSCP) of a header of the detected packet with a predetermined value, and transmits packet; and
a base station which determines whether to control traffic based on radio resource usage and non-controlled packet ratio and controls the traffic according to determination result.

11. The traffic control system of claim 10, wherein the base station measures the radio resource usage periodically, compares the measured radio resource usage with a predetermined threshold radio resource usage, determines, when the measured radio resource usage is greater than the threshold radio resource usage, to perform controlling the traffic from the EPC, and skips, when the measured radio resource usage is equal to or less than the threshold radio resource usage, controlling the traffic from the EPC.

12. The traffic control system of claim 11, wherein the base station compares, when the measured radio usage resource is greater than the threshold radio resource usage, the non-controlled packet ratio with a predetermined minimum threshold, skips, when the non-controlled packet ratio is equal to or less than the minimum threshold, controlling the traffic, and determines, when the non-controlled packet ratio is greater than the minimum threshold, controlling the traffic.

13. The traffic control system of claim 10, wherein the base station checks, when the packet is received, a traffic control flag, transmits, when the traffic control flag is set to Off, the received packet and determines, when the traffic control flag is set to On, whether to control the traffic by comparing the DSCP of the received packet with a predetermined reference DSCP.

14. The traffic control system of claim 13, wherein the base station transmits, when the DSCPs mismatch, the received packet and performs, when the DSCPs match, traffic control.

15. The traffic control system of claim 14, wherein the base station checks, when the DSCPs match, a controlled packet ratio to all transmission packets of entire traffic, drops, when the controlled packet ratio is greater than the threshold ratio, the received packet, and transmits, when the controlled packet ratio is equal to or less than the threshold ratio, the received packet.
